(19) United States
(12) Patent Application Publication
(10) Pub. No.: US 2011/0200869 A1
(43) Pub. Date: Aug. 18, 2011

(54) LITHIUM SECONDARY BATTERY AND METHOD FOR FABRICATING THE SAME

(76) Inventors: Mami Matsumoto, Osaka (JP); Kozo Watanabe, Osaka (JP); Toshitada Sato, Osaka (JP)

(21) Appl. No.: 13/124,768

(22) PCT Filed: Aug. 19, 2010
(86) PCT No.: PCT/JP2010/005118

§ 371 Date: Apr. 18, 2011

(30) Foreign Application Priority Data
Aug. 28, 2009 (JP) 2009-198182

(51) Int. Cl. H01M 2/02; H01M 10/04; H01M 4/04

(52) U.S. Cl. 429/163; 29/623.1; 29/623.2

(57) ABSTRACT

An electrode group 4 in which a positive electrode plate 1 and a negative electrode plate 2, each having on a surface of a current collector a mixture layer containing an active material, are wound or layered, with a porous insulating layer 3 interposed between the positive electrode plate 1 and the negative electrode plate 2, is sealed in a battery case 5 together with an nonaqueous electrolyte. Metallic particles 12 melted from a negative electrode current collector 10 are dispersed throughout a negative electrode mixture layer of the negative electrode plate 2. The metallic particles 12 are a metal which is melted from the negative electrode current collector 10 and which is deposited in the negative electrode mixture layer by reverse charging a lithium secondary battery and subsequently charging the lithium secondary battery.

### TECHNICAL FIELD

The present invention relates to lithium secondary batteries, and particularly relates to a structure of a negative electrode plate of the lithium secondary battery, and a method for fabricating the lithium secondary batteries.

### BACKGROUND ART

In recent years, production of portable and cordless electronic devices is rapidly increasing. As power supplies for these electronic devices, a demand for small, lightweight secondary batteries having a high energy density is increasing. Thus, there is an increasing interest in high-voltage, high-energy density nonaqueous electrolyte secondary batteries, in particular, lithium secondary batteries.

Crystalline carbon materials and amorphous carbon materials are, in general, known as carbon materials used as a negative electrode active material of a lithium secondary battery. In recent years, crystalline graphite is used in most cases. Graphite has a layered crystalline structure, and therefore, the electrical conductivity of graphite is anisotropic. This may increase a contact resistance between particles, depending on the state of contact between the particles, which results in a reduction in cycle characteristics.

Moreover, the polarization of the carbon material under a low temperature circumstance is increased if the contact resistance is increased. This may cause a problem in which when a reaction potential of the carbon material reaches a deposition potential of lithium, a large amount of metallic lithium is deposited on the surface of the negative electrode plate during charging at a low temperature (Patent Document 1).

To solve such a problem, Patent Document 1 discloses applying a metal coating to a surface of a carbon material powder. The metal coating layer formed on the surface of the carbon material powder has a high conductivity and isotropic electrical conductivity. Thus, it is possible to prevent the electrical conductivity from being reduced due to a contact resistance between the carbon material powders and the anisotropy of the graphite. Consequently, the cycle characteristics can be increased, and the deposition of the metallic lithium can be avoided.

### CITATION LIST

### Patent Document

PATENT DOCUMENT 1: Japanese Patent Publication No. H08-045548

### SUMMARY OF THE INVENTION

### Technical Problem

A carbon material as a negative electrode active material is mixed with a binder etc. to form a negative electrode mixture. This negative electrode mixture is applied to a negative electrode current collector and dried, and thereafter rolled to form a negative electrode plate. Thus, even if a metal coating is formed on the surface of the carbon material powder by the method described in Patent Document 1, the coating layer comes off in the subsequent rolling process, resulting in a reduction in electrical conductivity of the negative electrode plate.

The present invention was made in view of the above problem, and it is an objective of the invention to provide a lithium secondary battery having a negative electrode plate whose electrical conductivity is high and having superior cycle characteristics.

### Solution to the Problem

To solve the above problem, the present invention adopts a structure in which metallic particles melted from a negative electrode current collector are dispersed throughout a negative electrode mixture layer of the negative electrode plate. These metallic particles are a metal which is melted from the negative electrode current collector and which is deposited in the negative electrode mixture layer by reverse charging a lithium secondary battery and subsequently charging the lithium secondary battery.

Specifically, a lithium secondary battery according to one aspect of the present invention includes an electrode group in which a positive electrode plate and a negative electrode plate, each having on a surface of a current collector a mixture layer containing an active material, are wound or layered, with a porous insulating layer interposed between the positive electrode plate and the negative electrode plate, the electrode group being sealed in a battery case together with a nonaqueous electrolyte, wherein metallic particles melted from a negative electrode current collector are dispersed throughout a negative electrode mixture layer of the negative electrode plate.

According to this structure, since the metallic particles are dispersed throughout the negative electrode mixture layer, the electrical conductivity of the negative electrode plate can be increased. The metallic particles are a metal which is melted from the negative electrode current collector and which is deposited in the negative electrode mixture layer by reverse charging a lithium secondary battery and subsequently charging the lithium secondary battery. Thus, it is possible to ensure high electrical conductivity even after a rolling process. Further, the metallic particles can be dispersed in the negative electrode mixture layer by just reverse charging and subsequently charging the lithium secondary battery after fabrication, without adding a specific fabrication step for forming a metal coating layer on the surface of the negative electrode active material. Therefore, a negative electrode plate having a high electrical conductivity can be easily obtained. Consequently, low-cost lithium secondary batteries having superior cycle characteristics can be achieved.

According to another aspect of the present invention, it is preferable that the metallic particles are dispersed on a surface of a negative electrode active material of the negative electrode plate and/or an interface between the negative electrode current collector and the negative electrode active material. With this structure, the electrical conductivity of the negative electrode plate can be increased more.

A method for fabricating a lithium secondary battery according to another aspect of the present invention includes the steps of: forming an electrode group by winding or layering a positive electrode plate and a negative electrode plate, each having on a surface of a current collector a mixture layer containing an active material, with a porous insulating layer interposed between the positive electrode plate and the negative electrode plate; sealing the electrode group in a battery case together with a nonaqueous electrolyte; reverse charging by applying a reverse bias voltage between the positive electrode plate and the negative electrode plate; and after the reverse charging, charging by applying a forward bias voltage between the positive electrode plate and the negative electrode plate, wherein in the reverse charging, a metal which forms the negative electrode current collector is melted from the negative electrode current collector, and in the charging, the melted metal is deposited in a negative electrode mixture layer of the negative electrode plate.

According to this method, after fabricating a lithium secondary battery, the lithium secondary battery is reverse charged and subsequently charged under a predetermined condition. By doing so, the metal melted from the negative electrode current collector can be easily dispersed in the negative electrode mixture layer.

According to another aspect of the present invention, it is preferable that in the reverse charging, 0.08% to 3.2% of a rated capacity of the lithium secondary battery is reverse charged. By doing so, the electrical conductivity of the negative electrode plate can be significantly increased without deteriorating properties of the lithium secondary battery.

### Advantages of the Invention

According to the present invention, metallic particles melted from a negative electrode current collector can be dispersed throughout the entire negative electrode mixture layer, and therefore, it is possible to provide a lithium secondary battery having a negative electrode plate whose electrical conductivity is high and having superior cycle characteristics.

### BRIEF DESCRIPTION OF THE DRAWINGS

FIG. 1 is a schematic cross section of a structure of a lithium secondary battery according to one embodiment of the present invention.

FIG. 2 is a schematic cross section of a structure of a negative electrode plate according to one embodiment of the present invention.

FIG. 3 depicts the mechanism of how metallic particles according to the present invention are deposited in a negative electrode mixture layer. FIG. 3(a) shows the state when a lithium secondary battery is reverse charged. FIG. 3(b) shows the state when the lithium secondary battery is charged after the reverse charge.

FIG. 4 is an SEM image showing the state of a surface of a negative electrode plate after reverse charge according to one embodiment of the present invention.

### DESCRIPTION OF EMBODIMENTS

Embodiments of the present invention will be described in detail hereinafter, based on the drawings. The present invention is not limited to the following embodiments. Further, the disclosure of the invention can suitably be modified within the scope of the invention, or combined with other embodiments.

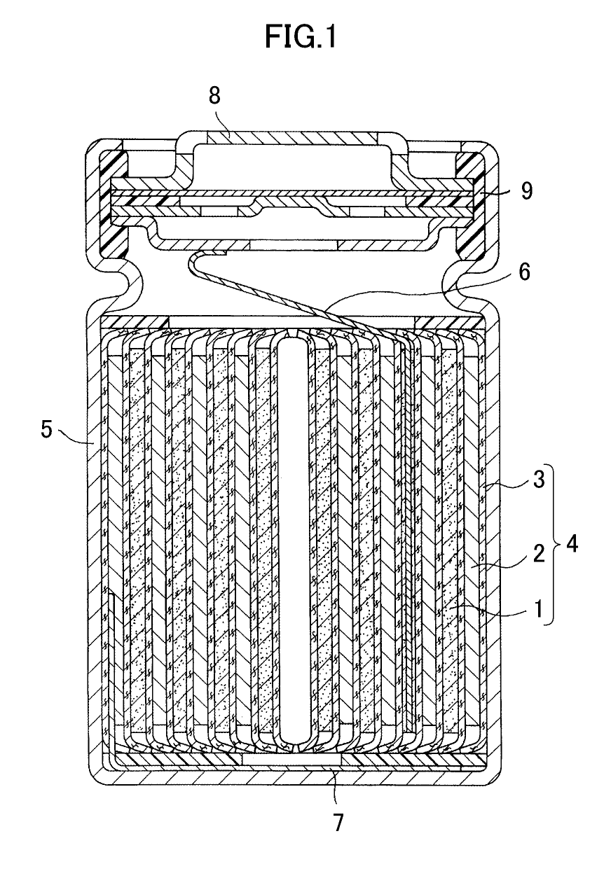

FIG. 1 is a schematic cross section of a structure of a lithium secondary battery according to one embodiment of the present invention.

As shown in FIG. 1, an electrode group 4 obtained by winding a positive electrode plate 1 and a negative electrode plate 2, with a porous insulating layer (separator) 3 interposed between the positive electrode plate 1 and the negative electrode plate 2, is sealed in a battery case 5 together with a nonaqueous electrolyte (not shown). In each of the positive electrode plate 1 and the negative electrode plate 2, a mixture layer containing an active material is formed on a surface of a current collector. The opening of the battery case 5 is sealed with a sealing plate 8 via a gasket 9. A positive electrode lead 6 attached to the positive electrode plate 1 is connected to the sealing plate 8 which also functions as a positive electrode terminal. A negative electrode lead 7 attached to the negative electrode plate 2 is connected to the bottom of the battery case 5 which also functions as a negative electrode terminal.

The structure of a lithium secondary battery according to the present invention is not limited to the structure shown in FIG. 1, and the present invention can be applied to a rectangular lithium secondary battery, for example. Further, materials for the components of the lithium secondary battery are not specifically limited, except a material for the negative electrode plate 2 described below. The electrode group 4 may be obtained by layering the positive electrode plate 1 and the negative electrode plate 2, with a separator 3 interposed between the positive electrode plate 1 and the negative electrode plate 2.

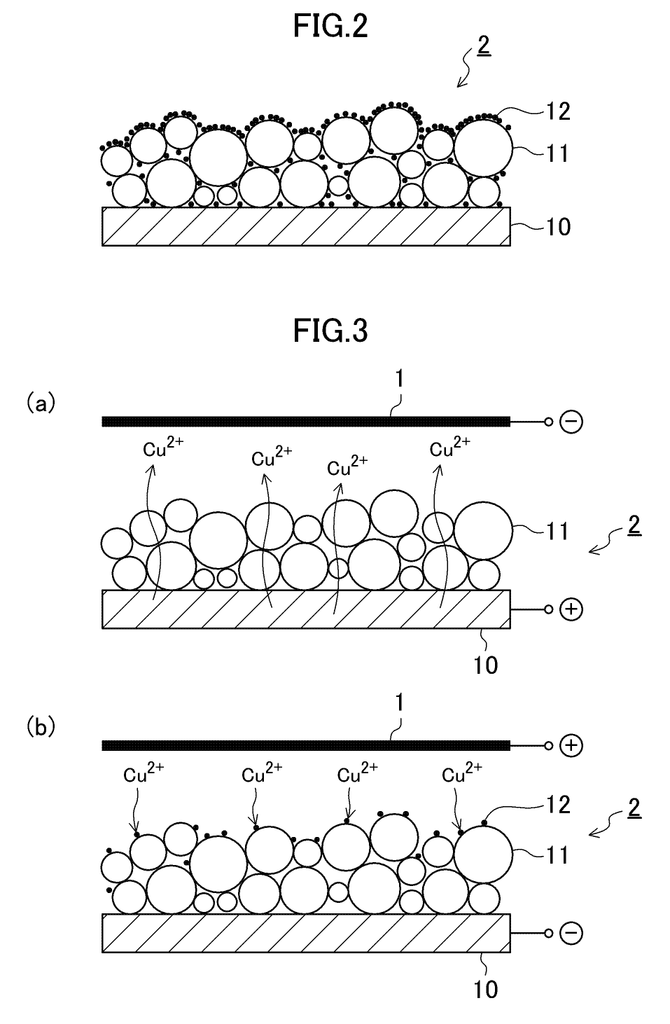

FIG. 2 is a schematic cross section of a structure of the negative electrode plate 2 according to the present embodiment. As shown in FIG. 2, a negative electrode mixture layer containing a negative electrode active material 11 is formed on a surface of the negative electrode current collector 10. Metallic particles 12 are dispersed throughout the entire negative electrode mixture layer. The metallic particles 12 are dispersed mainly on a surface of the negative electrode active material 11 of the negative electrode plate 2 and/or at an interface between the negative electrode current collector 10 and the negative electrode active material 11, but not necessarily uniformly dispersed throughout the entire negative electrode mixture layer.

Here, the negative electrode active material 11 is made of a carbon material, such as artificial graphite, natural graphite, coke, partially-graphitized carbon, carbon fiber, spherical carbon, and amorphous carbon. Further, the negative electrode active material 11 is a powder, whose particle size is not specifically limited, but preferably in a range of 1-40 μm.

Further, the negative electrode current collector 10 is made of a metal, such as Cu, Ni, Ag, Cr, Zn, and Cd, which does not form an alloy with lithium and which is melted at a potential below the decomposition potential of the nonaqueous electrolyte. The thickness of the negative electrode current collector 10 is not specifically limited. However, the thickness of the negative electrode current collector 10 is preferably in a range of 1-500 μm, and more preferably in a range of 5-20 μm.

Examples of the nonaqueous electrolyte include LiClO₄, LiBF₄, LiPF₆, etc. The nonaqueous electrolyte may be a liquid material, a gel material, or a solid material. The negative electrode mixture layer may include a binder in addition to the negative electrode active material 11. Examples of the binder include PolyVinylidene DiFluoride (PVDF), polytetrafluoroethylene, and polyethylene.

The metallic particle 12 of the present invention is a metal which is melted from the negative electrode current collector 10 and which is deposited in the negative electrode mixture layer by reverse charging the lithium secondary battery and subsequently charging the lithium secondary battery. The process will be described below with reference to FIGS. 3(a) and 3(b).

FIGS. 3(a) and 3(b) are schematic views of the state in which the positive electrode plate 1 and the negative electrode plate 2 in the lithium secondary battery shown in FIG. 1 face each other, with a separator (not shown) interposed therebetween. For only the negative electrode plate 2, the state in which a negative electrode mixture layer containing the negative electrode active material 11 is formed on the negative electrode current collector 10 is shown.

As shown in FIG. 3(a), in the case where the negative electrode current collector 10 is made of copper (Cu), a metal (Cu²⁺) is melted in the nonaqueous electrolyte (not shown) from the negative electrode current collector 10 when the lithium secondary battery is reverse charged by applying a reverse bias voltage (e.g., 2.5 V) between the positive electrode plate 1 and the negative electrode plate 2. The nonaqueous electrolyte permeates not only in the separator, but also in the negative electrode mixture layer. Thus, although not shown in FIG. 3(a), Cu²⁺ is melted in the nonaqueous electrolyte, as well, which permeates in the negative electrode active material 11.

The term “reverse charge” as used in the present invention is to charge by applying a negative potential to the positive electrode plate 1, and a positive potential to the negative electrode plate 2, that is, to apply potentials opposite to those applied during a general charge. This reverse charge is performed under given control. A suitable range of a reverse charge capacity in the rated capacity of the lithium secondary battery is determined.

Next, when the lithium secondary battery is charged by applying voltages of forward potentials (e.g., 3 V) to the positive electrode plate 1 and the negative electrode plate 2 after the reverse charge as shown in FIG. 3(b), the Cu²⁺ melted in the nonaqueous electrolyte is deposited in the negative electrode mixture layer. The Cu²⁺ is melted from the entire surface of the negative electrode current collector 10. Therefore, the metallic particles 12 (Cu) deposited in the negative electrode mixture layer are dispersed throughout the negative electrode mixture layer. The metallic particles 12 are deposited and dispersed mainly on the surface of the negative electrode active material 11 and/or at an interface between the negative electrode current collector 10 and the negative electrode active material 11.

Table 1 shows the results of evaluating the initial capacities and cycle characteristics of the lithium secondary batteries (having a height of 65 mm and a diameter of 18 mm) shown in FIG. 1 which were fabricated using an electrolytic copper foil (having a thickness of 8 μm) as the negative electrode current collector 10, and artificial graphite (having an average particle size of 16 μm) as the negative electrode active material 11, and which were thereafter reverse charged under various conditions.

TABLE 1

| | NEGATIVE | REVERSE | REVERSE | REVERSE | | CYCLE |
|---|---|---|---|---|---|---|
| | ELECTRODE | CHARGE | CHARGE | CHARGE | INITIAL | CHARAC- |
| | CURRENT | RATE | TIME | CAPACITY | CAPACITY | TERISTIC |
| | COLLECTOR | (C) | (min) | (%) | (mAh) | (%) |
| BATTERY 1 | Cu | 0.1 | 0.5 | 0.08 | 2008 | 83 |
| BATTERY 2 | | 1 | 0.17 | 0.27 | 2014 | 85 |
| BATTERY 3 | | 0.2 | 1 | 0.3 | 2018 | 81 |
| BATTERY 4 | | 0.2 | 5 | 1.6 | 2024 | 90 |
| BATTERY 5 | | 0.2 | 10 | 3.2 | 2021 | 87 |
| BATTERY 6 | | 0.2 | 30 | 10 | 1050 | — |
| BATTERY 7 | | 0.05 | 0.5 | 0.04 | 2010 | 71 |
| BATTERY 8 | | 0.05 | 1 | 0.08 | 2016 | 80 |
| BATTERY 9 | | — | — | — | 2013 | 71 |

In the positive electrode plate 1, an aluminum foil (having a thickness of 5 μm) was used as the positive electrode current collector; lithium nickelate was used as the positive electrode active material; and LiPF₆ was used as the nonaqueous electrolyte. The rated capacity of the obtained lithium secondary battery was 2000 mAh.

The batteries were reverse charged at a different reverse charge rate and for a different reverse charge time as shown in Table 1. After the reverse charge, the battery was charged such that the capacity charged was equal to or more than the capacity charged by the reverse charge. Here, the charge voltage is preferably 4.5 V or less which does not cause decomposition of the electrolyte.

The cycle characteristics were evaluated by performing the following charge/discharge cycle after the above reverse charge and the subsequent charge. Specifically, the battery was subjected to a constant current charge at a current of 1400 mA until the voltage reached 4.2 V, and thereafter, to a constant voltage charge at a voltage of 4.2 V until the current reached 100 mA. The battery was subjected to a low current discharge at a current of 2000 mA to a discharge end voltage of 3.0 V. The discharge capacity at the third cycle was set to 100%, and a capacity maintenance ratio (%) of the discharge capacity at the 500^{th} cycle was calculated to obtain cycle characteristics.

As shown in Table 1, the cycle characteristics of the batteries 1-5 whose reverse charge capacity to the rated capacity (2000 mAh) is 0.08% to 3.2% were significantly improved, compared to the battery 9 which was not reverse charged.

However, in the battery 6 whose reverse charge capacity was 10%, the initial capacity was too small to measure the cycle characteristics. This may be because if the reverse charge capacity is large, a metal is melted too much to a degree that the negative electrode current collector 10 cannot retain its original shape.

On the other hand, the cycle characteristic of the battery 7 whose reverse charge capacity is 0.04% was less improved than the cycle characteristic of the battery 9 which was not reverse charged. This may be because if the reverse charge capacity is small, almost no negative electrode current collector 10 is melted and therefore electrical conductivity of the negative electrode plate 2 is not increased.

The reverse charge capacity can be appropriately decided by a combination of the reverse charge rate and the reverse charge time. For example, the reverse charge capacity of the battery 8 is 0.08% that is obtained by setting the reverse charge rate to 0.05 C and the reverse charge time to one minute. The cycle characteristic of the battery 8 was improved as much as the cycle characteristic of the battery 1 whose reverse charge capacity is also 0.08% (which is obtained by setting the reverse charge rate to 0.1 C and the reverse charge time to 0.5 minute).

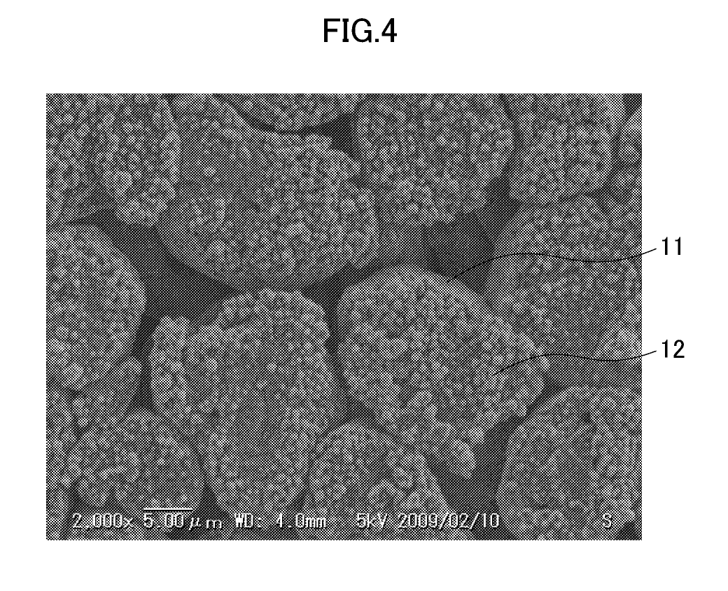

FIG. 4 is an SEM image showing the surface state of the negative electrode plate 2 of the battery 5 in Table 1, after the negative electrode plate 2 was reverse charged and subsequently charged. As shown in FIG. 4, Cu particles 12 are deposited on the surface of the negative electrode active material 11.

From the above results, the cycle characteristics of the lithium secondary battery can be significantly improved by reverse charging the lithium secondary battery such that the reverse charge capacity is in a range of 0.08% to 3.2% of the rated capacity of the lithium secondary battery. If the reverse charge is controlled to such a small capacity, the reverse charge does not cause any adverse effects on the positive electrode plate. Therefore, the initial capacity is not less than the initial capacity of the battery which was not reverse charged.

The reverse charge capacity according to the present invention can be appropriately decided by a combination of the reverse charge rate and the reverse charge time. Further, the reverse charge capacity may be decided in consideration of the specifications of the lithium secondary battery. In general, the cycle characteristic can be significantly improved by setting the reverse charge capacity to a range of 0.08% to 3.2% of the rated capacity of the lithium secondary battery.

According to the present invention, the conditions for a charge after a reverse charge are not specifically limited. After a reverse charge, the battery may be charged such that the capacity charged is equal to or more than the capacity charged by the reverse charge.

By performing the reverse charge and the subsequent charge according to the present invention immediately after the assembly of the lithium secondary battery, it is possible to achieve stable fabrication of lithium secondary batteries having superior cycle characteristics in a series of fabrication processes.

It is known that, in general, if a lithium secondary battery is reverse charged with the wrong polarity, the battery performance may be significantly deteriorated due to corrosion of the battery case or the current collector, or decomposition of the electrolyte, for example. In such an uncontrolled reverse charge, the capacity charged by the reverse charge is greater, in general, by one or more digits than the capacity charged by the reverse charge according to the present invention. Thus, the uncontrolled reverse charge is essentially different from the controlled reverse charge according to the present invention in which the reverse charge capacity is controlled to a small capacity. Accordingly, as a matter of course, the reverse charge of the present invention does not deteriorate the battery performance, unlike the uncontrolled reverse charge.

As mentioned earlier, a material for the negative electrode current collector 10 of the present invention is not specifically limited as long as the material does not form an alloy with lithium and is made of a material which is melted at a potential below the decomposition potential of the nonaqueous electrolyte.

Table 2 shows the results of evaluating the initial capacities and cycle characteristics of the lithium secondary batteries shown in FIG. 1 which were fabricated using nickel (Ni) as the negative electrode current collector 10, and which were thereafter reverse charged under the same conditions shown in Table 1. Evaluations were performed under the same conditions as in Table 1, except the conditions shown in Table 2.

TABLE 2

| | NEGATIVE | REVERSE | REVERSE | REVERSE | | CYCLE |
|---|---|---|---|---|---|---|
| | ELECTRODE | CHARGE | CHARGE | CHARGE | INITIAL | CHARAC- |
| | CURRENT | RATE | TIME | CAPACITY | CAPACITY | TERISTIC |
| | COLLECTCR | (C) | (min) | (%) | (mAh) | (%) |
| BATTERY 10 | Ni | 0.1 | 0.5 | 0.08 | 2021 | 81 |
| BATTERY 11 | | 0.2 | 1 | 0.3 | 2020 | 84 |
| BATTERY 12 | | 0.2 | 5 | 1.6 | 2019 | 89 |
| BATTERY 13 | | 0.2 | 10 | 3.2 | 2016 | 87 |
| BATTERY 14 | | 0.2 | 30 | 10 | 1320 | — |
| BATTERY 15 | | — | — | — | 2012 | 68 |

As shown in Table 2, the cycle characteristics of the batteries 10-13 whose reverse charge capacity to the rated capacity (2000 mAh) is 0.08% to 3.2% were significantly improved, compared to the battery 15 which was not reverse charged, also in the case where Ni is used as the negative electrode current collector 10, as in the case where Cu is used as the negative electrode current collector 10. Further, in the battery 14 whose reverse charge capacity was 10%, the initial capacity was too small to measure the cycle characteristics.

Table 3 shows the results of evaluating the initial capacities and the cycle characteristics of the lithium secondary batteries shown in FIG. 1 which were fabricated using silver (Ag), chromium (Cr), zinc (Zn), or cadmium (Cd) as the negative electrode current collector 10, and which were thereafter reverse charged under the same conditions of the battery 2 shown in Table 1. Evaluations were performed under the same conditions as in Table 1, except the conditions shown in Table 3.

TABLE 3

| | NEGATIVE | REVERSE | REVERSE | REVERSE | | CYCLE |
|---|---|---|---|---|---|---|
| | ELECTRODE | CHARGE | CHARGE | CHARGE | INITIAL | CHARAC- |
| | CURRENT | RATE | TIME | CAPACITY | CAPACITY | TERISTIC |
| | COLLECTCR | (C) | (min) | (%) | (mAh) | (%) |
| BATTERY 16 | Ag | 0.2 | 5 | 1.6 | 2013 | 88 |
| BATTERY 17 | Cr | 0.2 | 5 | 1.6 | 2015 | 87 |
| BATTERY 18 | Zn | 0.2 | 5 | 1.6 | 2020 | 89 |
| BATTERY 19 | Cd | 0.2 | 5 | 1.6 | 2003 | 85 |
| BATTERY 20 | Ag | — | — | — | 2018 | 72 |
| BATTERY 21 | Cr | — | — | — | 2008 | 68 |
| BATTERY 22 | Zn | — | — | — | 2020 | 67 |
| BATTERY 23 | Cd | — | — | — | 2005 | 67 |

As shown in Table 3, the cycle characteristics of the batteries 16-19 whose reverse charge capacity to the rated capacity (2000 mAh) is 1.6% were significantly improved, compared to the batteries 20-23 which were not reverse charged, also in the case where Ag, Cr, Zn, or Cd is used as the negative electrode current collector 10, as in the case where Cu or Ni is used as the negative electrode current collector 10.

A suitable embodiment of the present invention was described above. However, the present invention is not limited to the above descriptions, and of course, various changes can be made. For example, in the above embodiment, the rated capacity of the lithium secondary battery was 2000 mAh. However, the present invention can applied to a lithium secondary battery whose rated capacity is not 2000 mAh.

### INDUSTRIAL APPLICABILITY

A lithium secondary battery of the present invention is useful as a power supply for long-life portable electronic devices, or a power supply on vehicles such as hybrid vehicles.

### DESCRIPTION OF REFERENCE CHARACTERS

1 positive electrode plate
2 negative electrode plate
3 porous insulating layer (separator)
4 electrode group
5 battery case
6 positive electrode lead
7 negative electrode lead
8 sealing plate
9 gasket
10 negative electrode current collector
11 negative electrode active material
12 metallic particle

1. A lithium secondary battery, comprising:
an electrode group in which a positive electrode plate and a negative electrode plate, each having on a surface of a current collector a mixture layer containing an active material, are wound or layered, with a porous insulating layer interposed between the positive electrode plate and the negative electrode plate, the electrode group being sealed in a battery case together with a nonaqueous electrolyte, wherein
metallic particles melted from a negative electrode current collector are dispersed throughout a negative electrode mixture layer of the negative electrode plate.

2. The lithium secondary battery of claim 1, wherein
the metallic particles are a metal which is melted from the negative electrode current collector, and deposited in the negative electrode mixture layer by reverse charging the lithium secondary battery, and subsequently charging the lithium secondary battery.

3. The lithium secondary battery of claim 1, wherein
the metallic particles are dispersed on at least one of a surface of a negative electrode active material of the negative electrode plate, an interface between the negative electrode active materials, or an interface between the negative electrode current collector and the negative electrode active material.

4. The lithium secondary battery of claim 1, wherein
the negative electrode current collector is made of a metal which does not form an alloy with lithium and which is melted at a potential below a decomposition potential of the nonaqueous electrolyte.

5. The lithium secondary battery of claim 4, wherein
the negative electrode current collector is made of at least one metal selected from a group consisting of Cu, Ni, Ag, Cr, Zn, and Cd.

6. The lithium secondary battery of claim 1, wherein
a negative electrode active material of the negative electrode is a carbon material.

7. A method for fabricating the lithium secondary battery of claim 1, the method comprising the steps of:
forming an electrode group by winding or layering a positive electrode plate and a negative electrode plate, each having on a surface of a current collector a mixture layer containing an active material, with a porous insulating layer interposed between the positive electrode plate and the negative electrode plate;
sealing the electrode group in a battery case together with a nonaqueous electrolyte;
reverse charging by applying a reverse bias voltage between the positive electrode plate and the negative electrode plate; and
after the reverse charging, charging by applying a forward bias voltage between the positive electrode plate and the negative electrode plate, wherein
in the reverse charging, a metal which forms the negative electrode current collector is melted from the negative electrode current collector, and
in the charging, the melted metal is deposited in a negative electrode mixture layer of the negative electrode plate.

8. The method for fabricating the lithium secondary battery of claim 7, wherein
in the reverse charging, 0.08% to 3.2% of a rated capacity of the lithium secondary battery is reverse charged.

9. The method for fabricating the lithium secondary battery of claim 7, wherein
particles of the melted metal are deposited on a surface of a negative electrode active material of the negative electrode plate and/or an interface between the negative electrode current collector and the negative electrode active material.

10. The method for fabricating the lithium secondary battery of claim 7, wherein
the negative electrode current collector is made of a metal which does not form an alloy with lithium and which is melted at a potential below a decomposition potential of the nonaqueous electrolyte.

11. The method for fabricating the lithium secondary battery of claim 10, wherein
the negative electrode current collector is made of at least one metal selected from a group consisting of Cu, Ni, Ag, Cr, Zn, and Cd.

12. The method for fabricating the lithium secondary battery of claim 7, wherein
a negative electrode active material of the negative electrode is a carbon material.
